(19) United States
(12) Patent Application Publication
(10) Pub. No.: US 2014/0348669 A1
(43) Pub. Date: Nov. 27, 2014

(54) Pump Device for Ice Cream or Yogurt Machine

(71) Applicant: Lingyu Dong, Temple City, CA (US)

(72) Inventor: Lingyu Dong, Temple City, CA (US)

(21) Appl. No.: 14/452,493

(22) Filed: Aug. 5, 2014

Related U.S. Application Data
(63) Continuation-in-part of application No. 12/932,580, filed on Feb. 28, 2011.

(51) Int. Cl. F04C 14/24; A23G 9/22; B01F 5/14; F04C 13/00; F04C 2/14

(52) U.S. Cl. CPC F04C 14/24; F04C 13/001; F04C 2/14; B01F 5/14; A23G 9/224
USPC 417/53; 417/310

(57) ABSTRACT

A system includes a pump device for producing a mixture product, a casing having a concealed cavity for receiving the mixture product via the pump device; and a clutch unit operatively linked to the pump device for controllably maintaining an interior pressure of the concealed cavity at a predetermined threshold. Accordingly, the pump device is activated by the clutch unit for delivering the mixture product into the concealed cavity through an inlet of the casing until the interior pressure of the concealed cavity reaches the predetermined threshold and is deactivated by the clutch unit for stop delivering the mixture product into the concealed cavity when the interior pressure of the concealed cavity reaches the predetermined threshold.

### CROSS REFERENCE OF RELATED APPLICATION

This is a Continuation-In-Part application that claims the benefit of priority under 35 U.S.C. §119 to a non-provisional application, application Ser. No. 12/932,580, filed Feb. 28, 2011.

### BACKGROUND OF THE PRESENT INVENTION

1. Field of Invention

The present invention relates to a pump device, and more particularly to a pump device for a yogurt or ice-cream machine which is capable of preventing mixture leakage while allowing convenient cleaning of the pump device.

2. Description of Related Arts

A conventional pump for feeding liquid mixture for ice-cream or yogurt usually comprises a casing having a liquid inlet, an air inlet and a mixture outlet, and a plurality of intermeshing rotors, received in the casing to connect the liquid inlet, the air inlet and the mixture outlet. In particular, the intermeshing rotors are connected with each other to define a first chamber and a second chamber such that when one of the intermeshing rotors is rotated, another intermeshing rotor is driven to rotate to create a suction effect from the first chamber to the second chamber.

Conventionally, liquid and air enter the pump through the liquid inlet and air inlet respectively into the first chamber, wherein the liquid and air mix in the pump to form mixture which is then pumped out of the second chamber to feed an ice-cream or yogurt machine for making ice-cream or yogurt. There are several disadvantages regarding this conventional pump.

First, the rotors of the conventional pump are usually gears which must intermesh with each other in a very precise manner for facilitating effective mixing of liquid and air and for accomplishing efficient operation of the pump. As a result, each of the components of the pump, and especially the rotors, must be made very precise in order to allow each of the components to fit with each other for creating a suction effect between the first and second chambers and for effectively and efficiently making ice-cream or yogurt. All these requirements account for the very expensive manufacturing cost and their ultimate selling price of conventional pumps for ice-cream and yogurt machines.

Second, since the components of the conventional pumps must be very precise, it is very difficult for users of conventional pumps to disassemble and reassemble the pump for cleaning. As a matter of fact, since the pump is primarily used for pumping liquid having a relatively high viscosity, it needs cleaning regularly. However, the pump is usually mounted adjacent to the ice-cream or yogurt machine and should be connected to a tank or storage device for storing the liquid. The result is that it is very difficult for a user to detach the pump from other devices (such as the ice-cream machine) for cleaning. Likewise, it is very difficult or at least very inconvenient for the user to reassemble the pump and reattach it with other machines or devices.

Furthermore, when the components of the pump are made to be very precise, it is very difficult for users of the pump to reassemble the pump with the same precision as tough the pump was not disassembled. When the pump is not reassembled properly, the performance of the pump will be deteriorated and this in turn affects the quality or the efficiency of the ice-cream or yogurt produced.

In addition, since the casing is made of stainless steel, the intermeshing rotors must be made of different materials such as alloy. Accordingly, in order to provide a sealing effect between the first and second chambers, two side surfaces of each of the intermeshing rotors must be engaged with the two inner surfaces of the casing respectively such that the intermeshing rotors are engaged with the casing in a surface-to-surface contacting engagement to ensure the sealing effect between the first and second chambers. Otherwise, the mixture of liquid and air will leak to the second mixture through a clearance between the side surface of the intermeshing rotor and the inner surface of the casing. In other words, if the intermeshing rotor is made of stainless steel, which is the same material of the casing, heat will be substantially generated by the friction between the side surface of the intermeshing rotor and the inner surface of the casing when the intermeshing rotor is rotated. The heat will affect the quality of the ice-cream or yogurt.

In other words, the intermeshing rotors must be made of different materials such as alloy. When the teeth of the intermeshing rotors are meshed with each other to transmit the rotational power from one to another, the teeth of the intermeshing rotors are gradually torn, especially the teeth being precisely meshed. It is known that the durability of stainless steel is better than that of alloy. When the intermeshing rotors are made of stainless, the service life span of the intermeshing rotors will be substantially prolonged. However, it is impossible to incorporate the stainless steel made intermeshing rotors with stainless steel casing because of the extreme high heat generation as it is mentioned above.

Furthermore, the torn intermeshing rotors must be replaced every three months when the intermeshing rotors are made of alloy. Most importantly, the alloy residues of torn intermeshing rotors will mix with the ice-cream or yogurt through the suction effect of the pump from the first chamber to the second chamber. Therefore, the conventional pump for feeding liquid mixture for ice-cream or yogurt requires relatively high maintenance cost and creates harmful substance to our health.

Accordingly, the liquid mixture is continuously pumped into casing to make mixture product no matter the mixture product is dispensed out the casing. In other words, the pump will continuously activate to make the mixture product at any time to ensure the quality of the mixture product. Once the pump is deactivated to stop pumping the liquid mixture into the casing, the mixture product left in the casing will melt. It is a waste when the mixture product is not required for being made. As a result, the mixture product in the casing will be forced out through an overflow aperture at the casing. Furthermore, the continuously running the pump will shorten the life span thereof.

### SUMMARY OF THE PRESENT INVENTION

The invention is advantageous in that it provides a pump device for a frozen product machine, especially for a milk-frozen product such as yogurt or ice-cream machine, which can maintain the quality of the product at the time when it is dispensed.

Another advantage of the invention is to provide a pump device for a frozen product machine, wherein the run time of the pump device can be reduced from 80 to 95% comparing to the conventional pump device, so as to prolong the service life span of the pump device.

Another advantage of the invention is to provide a pump device for a frozen product machine, which can prevent the overflow of the pump device.

Another advantage of the invention is to provide a pump device for a frozen product machine, which is capable of preventing mixture leakage while allowing convenient cleaning of the pump device.

Another advantage of the invention is to provide a pump device for a frozen product machine, wherein the sealing arrangement is provided between two outer side surfaces of the rotor gears and two inner side surfaces of the pump casing. Therefore, the sealing arrangement not only provides a sealing effect for ensuring the liquid mixture and air being sealed and mixed within the pumping cavity through the rotor gears but also forms a partition for preventing the rotor gears from being direct-surface contact of the pump casing.

Another advantage of the invention is to provide a pump device for a frozen product machine, wherein no substantial heat is generated due to the friction between the rotor gears and the pump casing.

Another advantage of the invention is to provide a pump device for a frozen product machine, wherein the rotor gears and said pump casing are made of stainless steel to enhance the durability of the pump device so as to enhance the service life span thereof and to minimize any unwanted residue being formed when the rotor gears are gradually worn.

Another advantage of the invention is to provide a pump device for a frozen product machine, which facilitates easy and convenient assembling or disassembling of the pump casing.

Another advantage of the invention is to provide a pump device for a frozen product machine, wherein the components of the pump device can be made with less precision without jeopardizing the overall quality of the ice-cream or yogurt as compared to conventional pump devices. In other words, the manufacturing cost of the present invention can be minimized without affecting its performance.

Another advantage of the invention is to provide a pump device for a frozen product machine, which does not involve complicated or expensive mechanical components so as to minimize the manufacturing cost of the present invention.

Another advantage of the invention is to provide a pump device for a frozen product machine, wherein no expensive or complicate mechanical structure is required to employ in the present invention in order to achieve the above mentioned objects. Therefore, the present invention successfully provides an economic and efficient solution for providing a sealing effect within the pumping cavity for preventing direct surface contact between the rotor gears and the pump casing.

Additional advantages and features of the invention will become apparent from the description which follows, and may be realized by means of the instrumentalities and combinations particular point out in the appended claims.

According to the present invention, the foregoing and other objects and advantages are attained by providing a pump device for a frozen product machine, which comprises a pump casing, a plurality of rotor gears, and a sealing arrangement.

The pump casing has two inner side surfaces, a pumping cavity between the two inner side surfaces, a liquid inlet communicating the pumping cavity with an exterior of the pump device for allowing liquid mixture to be pumped into the pumping cavity through the liquid inlet, an air inlet communicating the pumping cavity for allowing intake of air through the air inlet to mix with the liquid mixture in the pumping cavity, and a mixture outlet communicated with the frozen product machine.

The rotor gears are fitted in the pumping cavity in a rotatably movable manner, wherein the rotor gears are driven to rotate to create a suction effect for pumping and mixing the liquid mixture with the air from the liquid inlet and the air inlet respectively to the mixture outlet so as to produce a mixture product.

The sealing arrangement comprises a plurality of sealing elements provided between two outer side surfaces of the rotor gears and the inner side surfaces of the pump casing for ensuring the liquid mixture and the air being sealed and mixed within the pumping cavity through the rotor gears and for preventing the rotor gears from being direct-surface contact of the pump casing.

In accordance with another aspect of the invention, the present invention comprises a method of making frozen product, comprising the following steps.

(1) Feed a liquid mixture and air into a pumping cavity of a pump casing through a liquid inlet and an air inlet thereof respectively.

(2) Drive two gear rotors to rotate within the pump casing for generating a suction effect to pump and mix the liquid mixture with the air to form a mixture product.

(3) Provide a sealing effect between two outer side surfaces of the rotor gears and two inner side surfaces of the pump casing by a sealing arrangement for ensuring the liquid mixture and the air being sealed and mixed within the pumping cavity through the rotor gears and for preventing the rotor gears from being direct-surface contact of the pump casing.

(4) Pump out the mixture product out of the pumping cavity through a mixture outlet of the pump casing.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an ice-cream or yogurt machine with a pump device according to a preferred embodiment of the present invention.

FIG. 2 is a perspective view of the pump device for an ice-cream or yogurt machine according to the above preferred embodiment of the present invention.

FIG. 3 is an exploded perspective view of the pump device for an ice-cream or yogurt machine according to the above preferred embodiment of the present invention.

FIG. 4 is a side sectional view of the pump device for an ice-cream or yogurt machine according to the above preferred embodiment of the present invention.

FIG. 5 is a top sectional view of the pump device for an ice-cream or yogurt machine according to the above preferred embodiment of the present invention.

FIG. 6 illustrates a modification of a system of an ice-cream or yogurt machine according to a second embodiment of the present invention.

### DETAILED DESCRIPTION OF THE PREFERRED EMBODIMENT

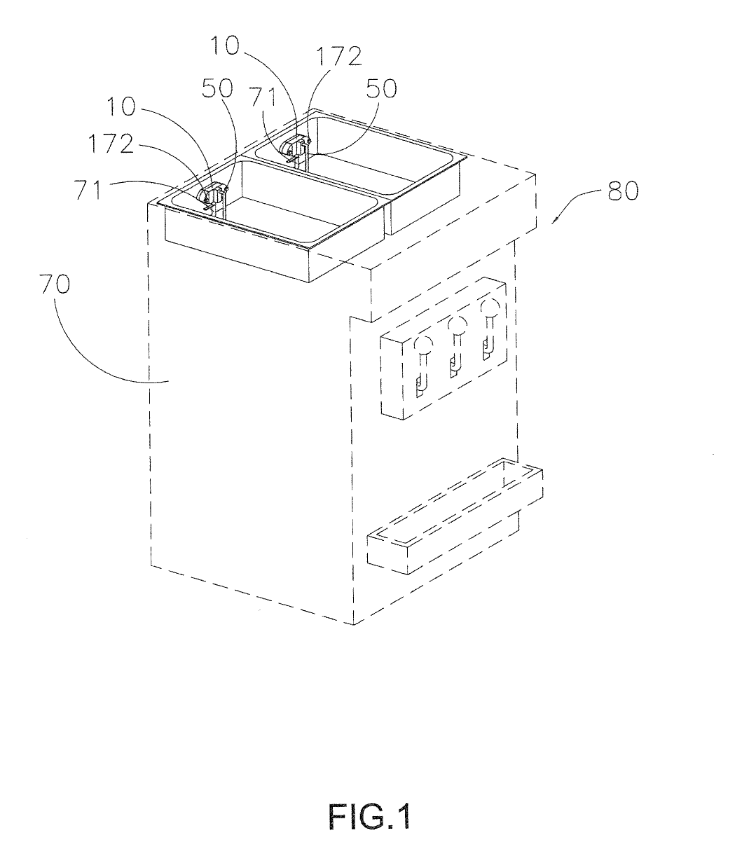

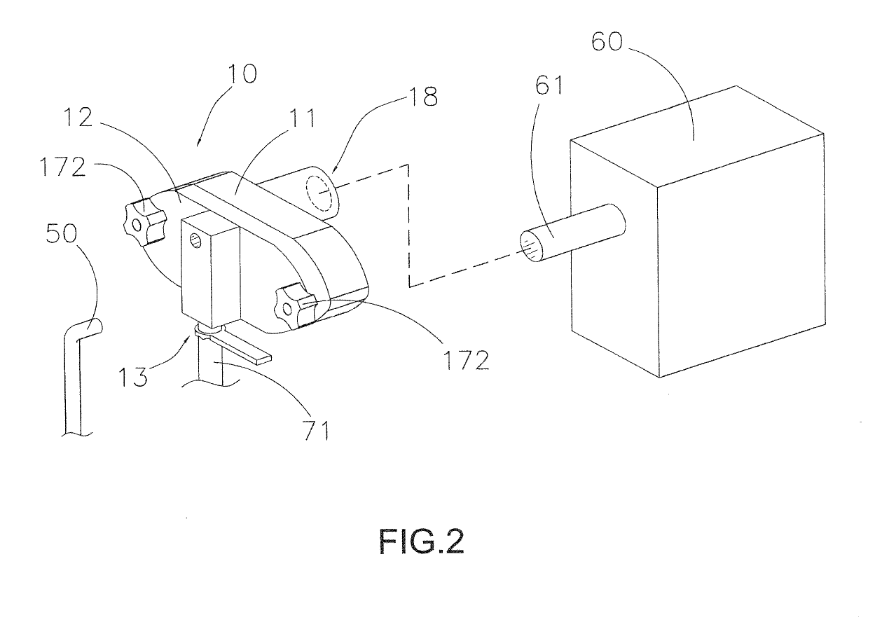

Referring to FIG. 1 to FIG. 5 of the drawings, a pump device for a frozen product machine 80, such as a yogurt machine or an ice-cream machine, according to a preferred embodiment of the present invention is illustrated, in which the pump device is embodied as a gear pump for the feeding and mixing of liquid and air for the formation of liquid and air emulsions as a mixture product. Accordingly, the pump device of the present invention comprises a pump casing 10, a plurality of rotor gears 20, 30, and a sealing arrangement 40.

The pump casing 10 has two inner side surfaces 101 and a pumping cavity 16 defined between the two inner side surfaces 101. The pump casing 10 further has a liquid inlet 13 communicating the pumping cavity 16, an air inlet 14 communicating the pumping cavity 16, and a mixture outlet 15 communicating the pumping cavity 16 with the frozen product machine 80.

According to the preferred embodiment, the pump device is embodied as a two-gear pump to define first and second rotor gears 20, 30 fitted in the pumping cavity 16 of the pump casing 10 in a rotatably movable manner, wherein the first and second rotor gears 20, 30 are driven to rotated to create a suction effect for pumping the mixing the liquid mixture with the air from the liquid inlet 13 and the air inlet 14 respectively to the mixture outlet 15 so as to produce the frozen product.

The sealing arrangement 40 comprises a plurality of sealing elements 41 provided between two outer side surfaces of the first and second rotor gears 20, 30 and the inner side surfaces 101 of the pump casing 10 for ensuring the liquid mixture and the air being sealed and mixed within the pumping cavity 16 through the first and second rotor gears 20, 30 and for preventing the first and second rotor gears 20, 30 from being direct-surface contact of the pump casing 10.

According to the preferred embodiment of the present invention, the pump device is for pumping raw material for yogurt or ice-cream in liquid form, mix it with air and deliver it to the yogurt or ice-cream device. The pump is therefore connected between a storage tank 70 and the yogurt or ice-cream machine 80.

Accordingly, the liquid mixture is fed into the pumping cavity 16 through the liquid inlet 13, wherein the liquid inlet 13 is formed at the pump casing 10 as a through communication channel communicating the pumping cavity 16 with an exterior of the pump device for allowing the liquid mixture to be pumped into the pumping cavity 16 through the liquid inlet 13. In other words, the liquid inlet 13 communicates the pumping cavity 16 with an exterior of the pump device for allowing liquid mixture, such as raw materials for making the yogurt or ice-cream, to be pumped from the storage tank 70 into the pumping cavity 16 through the liquid inlet 13.

The air inlet 14 is formed at the pump casing 10 for allowing intake of air through the air inlet 14 to mix with the liquid mixture in the pumping cavity 16. Once the liquid mixture is mixed with the air within the pumping cavity 16, the mixture product is produced and is delivered out of the pumping cavity 16 through the mixture outlet 15 to the frozen product machine 80 for whipping process.

According to the preferred embodiment, the pump casing 10 comprises a first casing member 11, a second casing member 12 detachably coupled with the first casing member 11 to form the pumping cavity 16 within the first and second casing members 11, 12. Accordingly, the two inner side surfaces 101 of the pump casing 10 form at the first and second casing members 11, 12 respectively.

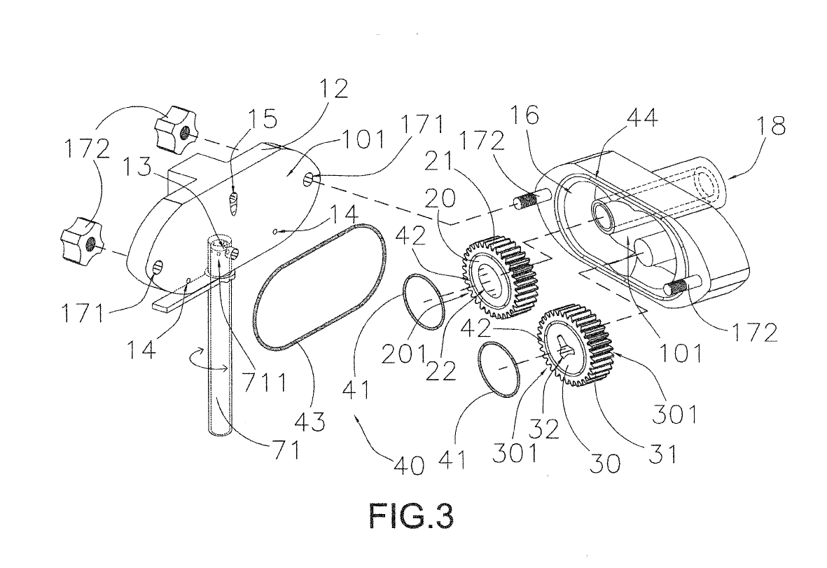

The pump casing 10 further comprises a plurality of fastening assemblies 17 operatively provided on the pump casing 10 for selectively fastening the first and second casing member 11, 12. As shown in FIG. 3 of the drawings, each of the fastening assemblies 17 contains a plurality of fastening holes 171 spacedly formed at the second casing member 12, a plurality of elongated threaded heads 173 spacedly extended from the first casing member 11 to alignedly extend through the fastening holes 171 respectively, and a plurality of threaded fastening knobs 172 operatively fastened to the threaded heads 173 after the threaded heads 173 extended through the fastening holes 171 for detachably fastening the corresponding portions of the first and the second casing member 11, 12. Note that the fastening assemblies 17 are provided at two side portions of the first and the second casing member 11, 12 so that each fastening assembly 17 is arranged to fasten the correspond side portions of the first and the second casing member 11, 12.

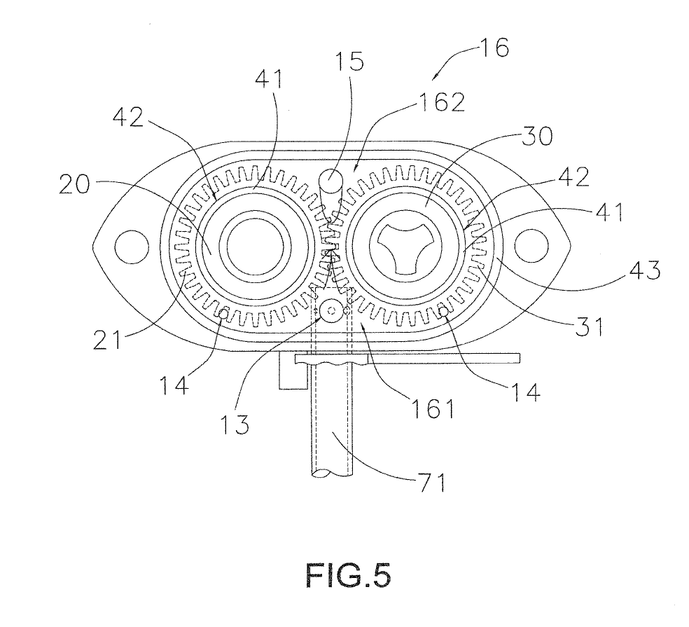

As shown in FIG. 5, the liquid inlet 13 is formed at bottom side of the pump casing 10. Preferably, the liquid inlet 13 is formed at the second casing member 12 of the pump casing 10. The liquid inlet 13 is connected to the storage tank 70 via a feeding tube 71, wherein the liquid mixture for making the ice-cream or yogurt is pumped into the pumping cavity 16 via the feeding tube 71 and the liquid inlet 13.

As shown in FIG. 3, the feeding tube 71 has a feeding end rotatably coupled at the liquid inlet 13, wherein a plurality of feeding holes 711 are spacedly formed at the feeding end of the feeding tube 71. The feeding holes 711 are formed with different diameters for selectively controlling the amount of the liquid mixture being fed into the pumping cavity 16, such that when the feeding tube 71 is adjustably rotated at a position that the pumping cavity 16 is alignedly communicated with one of the feeding holes 711, the liquid mixture is fed into the pumping cavity 16 via the corresponding feeding holes 711.

The air inlet 14 is formed at the front side of the pump casing 10 at a bottom portion thereof. Preferably, the air inlet 14 is formed at the second casing member 12 of the pump casing 10.

The mixture outlet 15 is formed at the front side of the pump casing 10 at an upper portion thereof. Preferably, the mixture outlet 15 is formed at the second casing member 12 of the pump casing 10.

The first and the second rotor gears 20, 30 are rotatably received in the pumping cavity 16 for creating a vacuum effect to suck liquid mixture and air through the liquid inlet 13 and the air inlet 14 into the pumping cavity 16. The first and the rotor gears 20, 30 also deliver pumping force to pump the mixture of the liquid mixture and the air out of the pumping cavity 16 through the mixture outlet 15.

Moreover, the pump casing 10 is communicated with a motor device 60 which is arranged to drive the rotor gears 20, 30 to rotate for sucking the liquid raw material and air into the pumping cavity 16, and creating a pumping force, i.e. the suction effect, to deliver the mixture product to the frozen product machine 80 for making the frozen product such as yogurt or ice-cream.

More specifically, the first rotor gear 20 has two outer side surfaces 201 and an outer circumferential edge portion between the two outer side surfaces 201. The first rotor gear 20 further comprises a plurality of first engaging teeth 21 peripherally formed along the outer circumferential edge portion of the first rotor gear 20.

The second rotor gear 30 has two outer side surfaces 301 and an outer circumferential edge portion between the two outer side surfaces 301. The second rotor gear 30 further comprises a plurality of second engaging teeth 31 peripherally formed along the outer circumferential edge portion of the second rotor gear 30, wherein the first engaging teeth 21 are meshed with the second engaging teeth 31 such that when the first gear rotor 20 is rotated, the second gear rotor 30 is driven to rotate. In other words, the first rotor gear 20 is the driving gear while the second rotor gear 30 is the driven gear. Thus, the first rotor gear 20 is connected to the motor device 60 which drives the first rotor gear 20 to rotate at a predetermined speed.

Thus, the pumping casing 10 further has a driving slot 18 formed on the first casing member 11, whereas the motor device 60 comprises a driving shaft 61 extended to connect with the first gear rotor 20 via the driving slot 18 so as to drive the first gear rotor 20 to rotate at a predetermined speed.

Thus, the first rotor gear 20 further has a first gear slot 22 formed at a mid-potion thereof, wherein the driving shaft 61 of the motor device 60 is arranged to connect to the first gear slot 22 through the driving slot 18 for driving the first rotor gear 20 to rotate. On the other hand, the second rotor gear 30 further has a second gear slot 32 whereas the pump casing 10 further comprises a supporting shaft 19 extended from the first casing member 11 to connect with the second gear slot 32, wherein the second rotor gear 30 is arranged to be driven to rotate by the first rotor gear 20 about the supporting shaft 19. The second rotor gear 30 further comprises an intermediate member 33 provided between the supporting shaft 19 and the outer circumferential edge portion 301 of the second rotor gear 30.

As shown in FIG. 5, the first rotor gear 20 are meshed with the second rotor gear 30 to define a first chamber 161 within the pumping cavity 16 to communicate with the liquid inlet 13 and a second chamber 162 within the pumping cavity 16 to communicate with the mixture outlet 15, wherein the pumping cavity 16 is sealed by the sealing arrangement 40 for ensuring the liquid mixture and air being mixed from the first chamber 161 to the second chamber 162 to form the mixture product.

Accordingly, when the first and second rotor gears 20, 30 are driven to rotate, the suction effect is created to feed the liquid mixture and air from the first chamber 161 to the second chamber 162. Therefore, the first and second chambers 161, 162 must be sealed tightly to ensure the leakage of the liquid mixture and air.

On the other hand, the pump casing 10 preferably has two air inlets 14 spacedly formed on the second casing member 12, wherein a predetermined amount of air is sucked into the pumping cavity 16 via the two air inlets 14 for mixing with the liquid mixture to form the mixture product which is to be delivered to the yogurt or ice-cream machine 80 through the mixture outlet 15.

Accordingly, the two air inlets 14 are formed at the bottom portion of the pump casing 10 to align with two bottom portions of the first and second gear rotors 20, 30 respectively, wherein the air is filled at the gaps between the engaging teeth 21, 31 of the first and second gear rotors 20, 30 such that the air will be delivered into the first chamber 161 during the rotational movements of the first and second gear rotors 20, 30.

As a result, the mixture outlet 15 is also formed on the second casing member 12 in such a manner that the mixture of liquid and air is to be delivered out of the pumping cavity 16 via the mixture outlet 15. A discharge tube 50 is connected between the mixture outlet 15 and the yogurt or ice-cream machine 80 for transporting the mixture from the pumping cavity 16 to the yogurt or ice-cream machine 80.

As it is mentioned above, the conventional design of the pump device is that the outer side surface 201, 301 of each of the first and second rotor gears 20, 30 must be tightly engaged with the corresponding inner side surface 101 of the pump casing 10 to prevent the leakage of the liquid mixture and air through the clearance between the outer side surfaces 201, 301 of the first and second rotor gears 20, 30 and the inner side surface 101 of the pump casing 10.

According to the preferred embodiment, the sealing arrangement 40 is provided at the clearance between the outer side surfaces 201, 301 of the first and second rotor gears 20, 30 and the inner side surface 101 of the pump casing 10. Therefore, the outer side surfaces 201, 301 of the first and second rotor gears 20, 30 will not contact with the inner side surface 101 of the pump casing 10 while sealing effect is provided at the clearance.

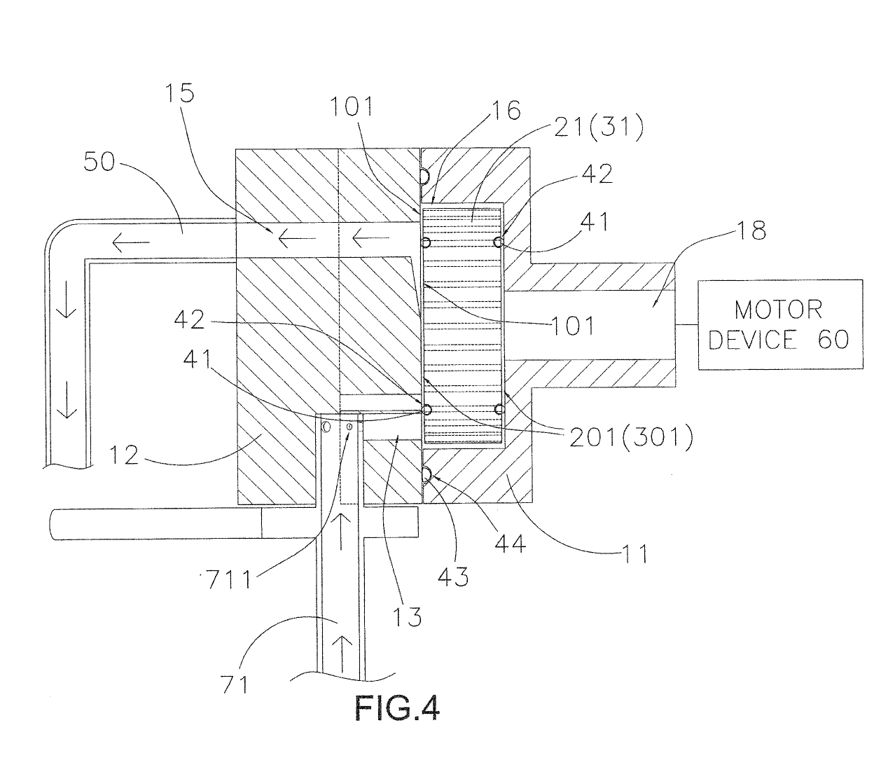

As shown in FIGS. 3 and 4, each of the sealing elements 41 is made of elastic material adapted to be deformed to fit between the outer side surface 201, 301 of each of the first and second rotor gears 20, 30 and the corresponding inner side surface 101 of the pump casing 10 so as to create the sealing effect therebetween while enabling each of the rotor gears 20, 30 being rotated within the pumping cavity 16.

Preferably, each of the sealing elements 41 is made of rubber material which is capable of preventing air and liquid from passing through the area sealed by the corresponding sealing elements 41.

As shown in FIGS. 3 and 4, each of the sealing elements 41 is embodied as a sealing ring retained at the outer side surface 201, 301 of each of the first and second rotor gears 20, 30 to bias against the corresponding inner side surface 101 of the pump casing 10. Therefore, the liquid mixture and air must pass from the first chamber 161 to the second chamber 162 through the meshing engagement between the first and second engaging teeth 21, 31 during the rotational movements of the first and second gear motors 20, 30. It is worth mentioning that the sealing elements 41 provide substantially complete sealing of the liquid mixture and the air so as to allow effective mixture of the air and the liquid within the pumping cavity 16 while facilitating easy and convenient disassembling and reassembling of the pump casing 10.

Thus, the sealing elements 41 are provided at the first and the second rotor gears 20, 30 respectively for preventing the air and the liquid sucked by the first and the second rotor gears 20, 30 from reaching the area sealed by the sealing elements 41 within the pumping cavity 16 (i.e. the central portion of each of the first and the second rotor gear 20, 30).

The sealing arrangement 40 further comprises a plurality of sealing slots 42 indent on the outer side surfaces 201, 301 of the first and second gear rotors 20, 30 respectively, wherein the sealing elements 41 are retained at the sealing slots 42 respectively to contact and seal with the inner side surfaces 101 of the pump casing 10.

Each of the sealing slots 42 is shaped corresponding to the respective sealing element 41, wherein when the sealing element 41 is disposed at the sealing slot 42, a portion of the sealing element 41 is received in the sealing slot 42 to retain the sealing element 41 in position while another portion of the sealing element 41 is protruded out of the outer side surfaces 201, 301 of the respective first and second gear rotors 20, 30 so as to bias against the respective inner side surface 101 of the pump casing 10.

Accordingly, each of the sealing elements 41 is embodied as a substantially circular sealing ring received in the sealing slots 42. Accordingly, each of the sealing slots 42 is also substantially circular in cross section which is arranged to fittedly accommodate the corresponding sealing element 41. Note that the sealing slot 42 at the second rotor gear 30 is formed at the boundary between the intermediate member 33 and the outer circumferential edge portion of the second rotor gear 30.

Since the sealing elements 41 are pressed between the outer side surface 201, 301 of each of the first and second rotor gears 20, 30 and the corresponding inner side surface 101 of the pump casing 10, the first and second rotor gears 20, 30 will not directly contact with the pump casing 10 in a surface-to-surface contacting manner. Therefore, there will be no heat generation by the friction between the outer side surfaces 201, 301 of the first and second rotor gears 20, 30 and the inner side surfaces 101 of the pump casing 10 during the rotational movements of the first and second gear motors 20, 30.

After solving the unwanted heat generated problem, all the pump casing 10, and the first and second rotor gears 20, 30 can be made of stainless steel. When both the first and second rotor gears 20, 30 are made of stainless steel, the durability of the first and second engaging teeth 21, 31 will be substantially enhanced to prolong the service life span of the first and second rotor gears 20, 30. As it is mentioned above, if the first and second rotor gears 20, 30 are made of alloy, they must be frequently replaced for every three months. When the first and second rotor gears 20, 30 are made of stainless steel, they can be frequently replaced for every three years. Accordingly, there will be no or relatively less amount of residues formed during the rotational movements of the first and second gear motors 20, 30, wherein such amount of residues is under the safety level.

It is worth mentioning that since the pump device is substantially sealed by the sealing arrangement 40, the engagement between the first and the second rotor gears 20, 30 can be made less precise as compared to conventional pumping devices. This eventually reduces the manufacturing cost and the ultimate selling price of the present invention.

The sealing arrangement 40 further comprises a casing sealing element 43 provided between the first and second casing members 11, 12 to seal the pumping cavity 16 within the first and second casing members 12, 12 when the first and second casing members 11, 12 are coupled together.

The sealing arrangement 40 further has a retention slot 44 indent at the peripheral portion of the first casing member 11 to retain the casing sealing element 43 thereat so as to bias against the second casing member 12 when the first and second casing members 11, 12 are coupled together.

Likewise, the casing sealing element 43 is made of rubber material which is capable of preventing air and liquid from passing through the area sealed by the casing sealing element 43. Accordingly, the casing sealing element 43 is arranged to encircle a peripheral edge portion of the first and the second casing member 11, 12. Thus, the retention slot 44 is indently formed on the first casing member 11 at a position encircling a peripheral side edge portion thereof so as to prevent air and liquid leakage from the pumping cavity 16. When the pumping cavity 16 is sealed from ambient atmosphere, the efficiently of the pump device of the present invention can be substantially enhanced because the pumping action of the pump device is accomplished by rotation of the first and the second rotor gear 20, 30, which creates a vacuum effect in the pumping cavity 16 for sucking liquid from the storage tank 70 and the air from the surrounding environment.

The operation of the present invention is as follows: a user of the present invention will first put raw materials in liquid form into the storage tank 70. When the motor device 60 is operated, the first and the second rotor gears 20, 30 will be driven to rotate for creating a vacuum effect in the pumping cavity 16. As a result, the raw materials stored in the storage tank 70 will then be sucked into the pumping cavity 16 through the liquid inlet 13. Air will also be sucked into the pumping cavity 16 through the air inlet 14. The air will then mix with the raw materials in liquid form to become the mixture product, which is discharged through the mixture outlet 15 of the pump casing 10. The sealing arrangement 40 ensures substantial sealing of the pumping cavity 16 which reduces the manufacturing cost of other components of the pump device and provide efficient and effective vacuum of the pumping cavity 16.

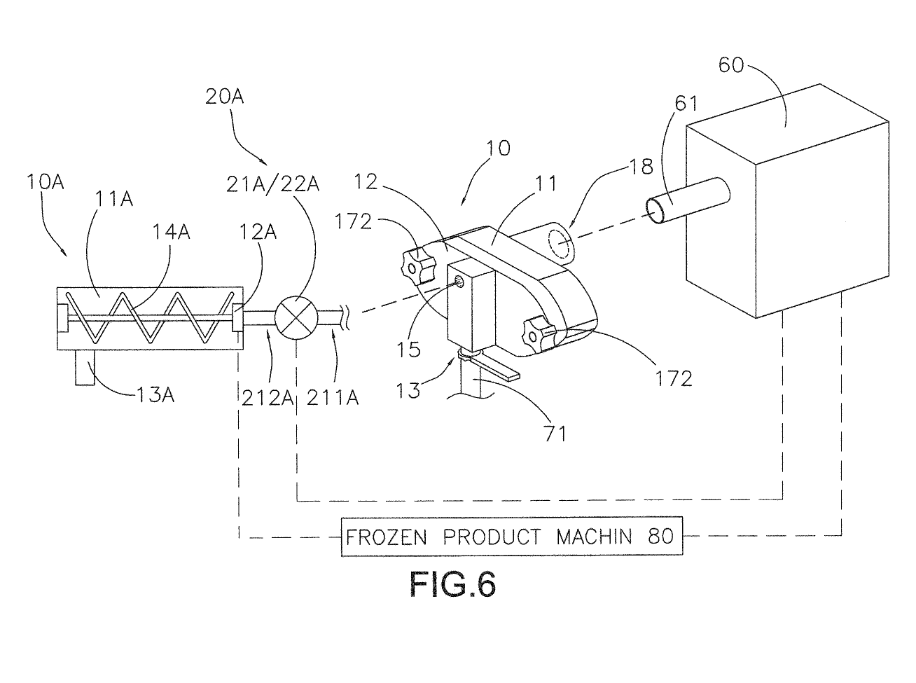

As shown in FIG. 6, a modification of a system of an ice-cream or yogurt machine according to a second embodiment of the present invention is illustrated, wherein the system further comprises a casing 10A and a clutch unit 20A operatively linked between the pump device and the casing 10A.

The casing 10A has a concealed cavity 11A, an inlet 12A for allowing the mixture product to be input into the concealed cavity 11A via the pump device, and an outlet 13A for dispensing the mixture product from the concealed cavity 11A. The casing 10A is made of heat-insulated material to maintain the temperature of the mixture product within the concealed cavity 11A. Accordingly, the interior pressure of the concealed cavity 11A is defined when the outlet 13A is closed.

The clutch unit 20A is operatively linked to the pump device for controllably maintaining the interior pressure of the concealed cavity 11A at a predetermined threshold. In particular, the pump device is activated by the clutch unit 20A for delivering the mixture product into the concealed cavity 11A through the inlet 12A until the interior pressure of the concealed cavity 11A reaches the predetermined threshold. The pump device is also deactivated by the clutch unit 20A for stop delivering the mixture product into the concealed cavity 11A when the interior pressure of the concealed cavity 11A reaches the predetermined threshold. Accordingly, the clutch unit 20A is operatively linked to the motor device 60 of the pump device, such that the motor device 60 is controllably activated by the clutch unit 20A. Therefore, the run time of the pump device will be minimized that the pump device will be activated only in response to the interior pressure of the concealed cavity 11A.

Accordingly, when the mixture product is fed into the concealed cavity 11A of the casing 10A, the interior pressure of the concealed cavity 11A will be increased. It is worth mentioning that the pump device is activated to feed the mixture product into the concealed cavity 11A while the outlet 13A of the casing 10A is closed. Once the interior pressure of the concealed cavity 11A reaches the predetermined threshold, the pump device is deactivated, such that no mixture product will be fed into the concealed cavity 11A. When the interior pressure of the concealed cavity 11A reaches the predetermined threshold, the interior pressure of the concealed cavity 11A will be higher than an exterior pressure of the concealed cavity 11A.

In order to reduce the interior pressure of the concealed cavity 11A, the outlet 13A of the casing 10A is opened to dispense the mixture product therein. Accordingly, the pump device is activated/re-activated by the clutch unit 20A when the outlet 21A of the casing 10A is opened to reduce the interior pressure of the concealed cavity 11A below the predetermined threshold. It is worth mentioning that the clutch unit 20A is arranged to maintain the interior pressure of the concealed cavity 11A at the predetermined threshold. Therefore, when the interior pressure of the concealed cavity 11A drops below the predetermined threshold, the pump device is activated. Likewise, when the interior pressure of the concealed cavity 11A reaches the predetermined threshold, the pump device is deactivated. As a result, the pump device will not be operated all the time.

As shown in FIG. 6, the casing 10A further comprises a stirring unit 14A operatively supported in the concealed cavity 11A for stirring the mixture product within the concealed cavity 11A. Accordingly, the stirring unit 14A comprises a longitudinal propeller coaxially and rotatably supported within the concealed cavity 11A for delivering and stirring the mixture product from the inlet 12A to the outlet 13A of the casing 10A in a spirally delivering manner. Accordingly, the stirring unit 14A can be operatively linked to the frozen product machine 80.

As shown in FIG. 6, the clutch unit 20A comprises a one-way check valve 21A having a valve inlet 211A operatively linked to the mixture outlet 15 of the pump casing 10 of the pump device and a valve outlet 212A operatively linked to the inlet 12A of the casing 10A. Therefore, the mixture product will be delivered to the concealed cavity 11A from the pump device through the one-way check valve 21A. However, the mixture product cannot be returned back to the pump device from the concealed cavity 11A.

Accordingly, when the outlet 13A of the casing 10A is closed and the pump device is activated, the one-way check valve 21A is opened for letting the mixture product to deliver to the concealed cavity 11A. When the outlet 13A of the casing 10A is closed and the pump device is deactivated, the one-way check valve 21A is closed to maintain the interior pressure of the concealed cavity 11A at the predetermined threshold.

The one-way check valve 21A is closed by the pressure difference of the casing 10A. The one-way check valve 21A is closed when the interior pressure of the concealed cavity 11A is higher than an exterior pressure of the concealed cavity 11A.

Alternatively, the clutch unit 20A comprises a timer switch 22A operatively linked to the pump device, wherein the timer switch 22A is arranged to activate the pump device after the outlet 13A of the casing 10A is opened for a predetermined opening time. In other words, once the outlet 13A of the casing 10A is opened for dispensing the mixture product for a predetermined opening time, the pump device will be activated by the timer switch 22A. It is worth mentioning that the dispensing rate of the mixture product at the outlet 13A of the casing 10A is known. Once the outlet 13A of the casing 10A is opened, the mixture product will be dispensed from the concealed cavity 11A until it is empty. Before emptying the concealed cavity 11A, the pump device will be activated by the timer switch 22A to feed the mixture product into the concealed cavity 11A. For example, the opening time of the outlet 13A is set as five seconds. Therefore, after the outlet 13A is opened for five seconds to dispense the mixture product, i.e. reducing the interior pressure of the concealed cavity 11A, the pump device will be activated by the timer switch 22A.

Furthermore, the feeding rate of the mixture product of the pump device to feed the mixture product to the casing 10A is known. Therefore, the timer switch 22A will deactivate the pump device after a predetermined activating time of the pump device. For example, after the pump device is activated for one minute to feed the mixture product into the concealed cavity 11A, i.e. increasing the interior pressure thereof, the pump device will be deactivated by the timer switch 22A after one minute of activating time.

According to the preferred embodiment, the pump device will be activated only when the interior pressure of the casing 10A is below the predetermined threshold. Therefore, the pump device will be stopped to pump out the mixture product so as to prevent the overflow of the pump device. Furthermore, the mixture product is stored and concealed in the concealed cavity 11A under a higher pressure with respect to the exterior pressure of the casing 10A. The quality of the mixture product will be maintained as the mixture product freshly made at the pump device once the liquid mixture is freshly mixed with the air. The system of the present invention is an environmentally friendly product that the pump device will be activated only as necessary while being energy efficient.

One skilled in the art will understand that the embodiment of the present invention as shown in the drawings and described above is exemplary only and not intended to be limiting. It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A system for a frozen product machine, comprising:
a pump device for mixing liquid mixture with air to produce a mixture product;
a casing having a concealed cavity, an inlet for allowing said mixture product to be input into said concealed cavity via said pump device, and an outlet for dispensing said mixture product from said concealed cavity; and
a clutch unit operatively linked to said pump device for controllably maintaining an interior pressure of said concealed cavity at a predetermined threshold, wherein said pump device is activated by said clutch unit for delivering said mixture product into said concealed cavity through said inlet until said interior pressure of said concealed cavity reaches said predetermined threshold and is deactivated by said clutch unit for stop delivering said mixture product into said concealed cavity when said interior pressure of said concealed cavity reaches said predetermined threshold.

2. The system, as recited in claim 1, wherein said pump device is activated by said clutch unit when said outlet of said casing is opened to reduce said interior pressure of said concealed cavity below said predetermined threshold.

3. The system, as recited in claim 1, wherein said clutch unit comprises a one-way check valve having a valve inlet operatively linked to a mixture outlet of said pump device and a valve outlet operatively linked to said inlet of said casing, wherein when said outlet of said casing is closed and said pump device is activated, said one-way check valve is opened for letting said mixture product to deliver to said concealed cavity, wherein when said outlet of said casing is closed and said pump device is deactivated, said one-way check valve is closed to maintain said interior pressure of said concealed cavity at said predetermined threshold.

4. The system, as recited in claim 2, wherein said clutch unit comprises a one-way check valve having a valve inlet operatively linked to a mixture outlet of said pump device and a valve outlet operatively linked to said inlet of said casing, wherein when said outlet of said casing is closed and said pump device is activated, said one-way check valve is opened for letting said mixture product to deliver to said concealed cavity, wherein when said outlet of said casing is closed and said pump device is deactivated, said one-way check valve is closed to maintain said interior pressure of said concealed cavity at said predetermined threshold.

5. The system, as recited in claim 1, wherein said casing further comprises said stirring unit operatively supported in said concealed cavity for stirring said mixture product within said concealed cavity.

6. The system, as recited in claim 2, wherein said casing further comprises said stirring unit operatively supported in said concealed cavity for stirring said mixture product within said concealed cavity.

7. The system, as recited in claim 4, further comprising said stirring unit operatively supported in said concealed cavity for stirring said mixture product within said concealed cavity.

8. The system, as recited in claim 5, wherein said pump device comprises a motor device operatively linked to clutch unit.

9. The system, as recited in claim 1, wherein said pump device comprises a motor device operatively linked to clutch unit.

10. The system, as recited in claim 7, wherein said pump device comprises a motor device operatively linked to clutch unit.

11. A method of making frozen product, comprising the steps of:
(a) activating a pump device by a clutch unit for delivering a mixture product into a concealed cavity of a casing through an inlet thereof, so as to increase an interior pressure of said concealed cavity; and
(b) deactivating said pump device by said clutch for stop delivering said mixture product into said concealed cavity when said interior pressure of said concealed cavity reaches a predetermined threshold so as to controllably maintain said interior pressure of said concealed cavity at said predetermined threshold.

12. The method, as recited in claim 11, further comprising a step of operatively linking a valve inlet and a valve outlet of a one-check valve at mixture outlet of said pump device and said inlet of said casing respectively.

13. The method, as recited in claim 12, wherein said one-check valve is operated by the steps of:
opening said one-way check valve letting said mixture product to deliver to said concealed cavity when said outlet of said casing is closed and said pump device is activated; and
closing said one-way check valve to maintain said interior pressure of said concealed cavity at said predetermined threshold when said outlet of said casing is closed and said pump device is deactivated.

14. The method, as recited in claim 11, further comprising a step of re-activating said pump device by said clutch unit for pumping said liquid mixture into said concealed cavity when an outlet of said casing is opened to release said mixture product from said concealed cavity and to reduce said interior pressure of said concealed cavity below said predetermined threshold.

15. The method, as recited in claim 12, further comprising a step of re-activating said pump device by said clutch unit for pumping said liquid mixture into said concealed cavity when an outlet of said casing is opened to release said mixture product from said concealed cavity and to reduce said interior pressure of said concealed cavity below said predetermined threshold.

16. The method, as recited in claim 13, further comprising a step of re-activating said pump device by said clutch unit for pumping said liquid mixture into said concealed cavity when an outlet of said casing is opened to release said mixture product from said concealed cavity and to reduce said interior pressure of said concealed cavity below said predetermined threshold.

17. The method, as recited in claim 11, further comprising a step of stirring said mixture product within said concealed cavity via a stirring unit.

18. The method, as recited in claim 16, further comprising a step of stirring said mixture product within said concealed cavity via a stirring unit.

19. The method, as recited in claim 11, wherein said clutch unit is operatively linked to a motor device of said pump device.

20. The method, as recited in claim 18, wherein said clutch unit is operatively linked to a motor device of said pump device.
